(19) United States
(12) Patent Application Publication
(10) Pub. No.: US 2004/0075815 A1
(43) Pub. Date: Apr. 22, 2004

(54) Projection device with a microprocessor module

(76) Inventor: Shin-Pin Huang, Taipei (TW)

Correspondence Address: HAVERSTOCK & OWENS LLP, 162 NORTH WOLFE ROAD, SUNNYVALE, CA, 94086, US

(21) Appl. No.: 10/685,666

(22) Filed: Oct. 14, 2003

(30) Foreign Application Priority Data
Oct. 15, 2002 (TW) 091216412

(51) Int. Cl. G03B 21/26

(52) U.S. Cl. 353/30

(57) ABSTRACT

A projection device with a microprocessor module is provided. The projection device includes a microprocessor module for receiving a data signal including an image format file, a document format file, and a video format file to be converted into an output signal; and a projector electrically connected to the microprocessor module for receiving the output signal.

### FIELD OF THE INVENTTON

The present invention is related to a projection device, and more particularly, to a projection device with a microprocessor module.

### BACKGROUND OF THE INVENTION

As the computer is available to all, the peripheral devices are more and more popular. One of them is the projector. The common basic requests for a projector are portability, light-weight, and usage convenience. Nowadays, the projector is developed in the direction with compact size, light-weight, and high quality.

Presently, there are two kinds of projection devices which are classified by size the fixed projector and the portable projector. The advantage of the fixed projector is the highly powerful function, which can project the real images of objects, films, and transparencies onto a wall. It has the function of electrical focusing and can enlarge image with steplessly adjustable value, etc. It also has multi-signal input/output, so that it can be used as a central controller. However, the disadvantages of the fixed projector are bulky size and heavy weight. Besides, it also needs additional data input devices to be the data sources when using. And a fixed projector with high quality usually has a higher price. On the other hand, the advantages of the portable projector are the light-weight feature, and the data input device is built in with. With the exception that the portable projector can't project films and transparencies, the other functions of that can be entirely as good as the functions of a professional protocol.

A portable projector further includes a memory card slot. Through the presentation function of the projector (PC card viewer), it is very convenient to preview the graphic files stored in the memory card without any other computer devices. But the conventional portable projector with a memory card slot call only play graphic files stored in few certain file formats, such as JPEG or PNG format or PowerPoint format files developed by the Microsoft Corporation. However the PowerPoint format files need to be transformed into graphic format files first before being processed by the projector, which is very inconvenient. Besides, it is very impractical for an user that only the PowerPoint format can be used in the projector among all other Windows Office formats. Therefore, how to design a projector capable of accepting and playing files stored in all formats has become a major problem waited to be solved in the industry.

### SUMMARY OF THE INVENTION

It is the main object of the present invention to provide a projection device with a microprocessor module.

It is another object of the present invention to provide a, projection device for playing multi-type file formats without the need of connecting with a computer.

It is another object of the present invention to provide a projection device with usage convenience that there is no need to transform the file formats before using the projector. Also, since there is no limitation of file formats, the application range for a projection device can be largely increased.

According to one aspect of the present invention, the projection device includes a microprocessor module for receiving a data signal including an image format file, a document format file, and a video format file to be converted into an output signal; and a projector electrically connected to the microprocessor module for receiving the output signal.

Preferably, the microprocessor module further includes a data input device for receiving the data signal; a data processing device electrically connected to the data input device for converting the data signal into the output signal; and a signal output device electrically connected to the data processing device for providing the output signal to the projector.

Preferably, the data input device includes a network interface connector to be an input interface thereof.

Preferably, the data input device includes a serial port connector to be an input interface thereof.

Preferably, the data input device includes a universal serial bus connector to be an input interface thereof.

Preferably, the data input device includes an IEEE1394 connector to be an input interface thereof.

Preferably, the data input device includes a memory card slot to be an input interface thereof.

Preferably, the data processing device further includes a main processor for processing the data signal; a main memory for storing a data temporarily; and an erasable memory for storing basic communication protocols and all drivers of elements on the microprocessor module.

Preferably, the software operating system of the data processing device is Microsoft Windows CE.

Preferably, the software operating system of a data processing device includes a data processing software for processing Microsoft Office files and image files.

Preferably, the data processing device further includes a graphic processing unit (GFU) for processing a file having a digital video format.

Preferably, the GPU provides a processing means for file formats including MPEG1, MPEG2, MPEG4, AVI, REAL MEDIA, and QUICKTIME MOVIE.

Preferably, the signal output device further includes an audio-visual output module for transferring the output signal to the projector.

Preferably, the microprocessor module further includes a GPIO connector electrically connected to a peripheral device.

Preferably, the microprocessor module further includes an IR device for receiving an IR control signal.

According to another aspect of the present invention, the projection device with a microprocessor module includes a memory card device for being inserted therein by a memory card to provide a data signal including an image format file, a document format file, and a video format file; a microprocessor module for receiving the data signal to be converted into an output signal; and a projector electrically connected to the microprocessor module for receiving the output signal.

Preferably, the microprocessor module further includes a data input device for receiving the data signal, a data processing device electrically connected to the data input device for converting the data signal into the output signal; and a signal output device electrically connected to the data processing device for providing the output signal to the projector.

Preferably, the data processing device further includes a main processor for processing the data signal; a main memory for storing a data temporarily; and an erasable memory for storing basic communication protocols and all drivers of elements on the microprocessor module.

Preferably, the data processing device further includes a graphic process unit (GPU) for processing video format files.

Preferably, the signal output device further includes an audio-visual output module for transferring the output signal to the projector.

The foregoing and other features and advantages of the present invention will be more clearly understood through the following descriptions with reference to the drawings, wherein:

### BRIEF DESCRIPTION OF THE DRAWINGS

FIG. 1(a) illustrates a projection device with a microprocessor module according to a preferred embodiment of the present invention;

FIG. 1(b) illustrates an electrical block diagram of the microprocessor module according to a preferred embodiment of the present invention; and

FIG. 2 illustrates an electrical block diagram of the projection device with a microprocessor module according to a preferred embodiment of the present invention.

### DETAILED DESCRIPTION OF THE PREFERRED EMBODIMENT

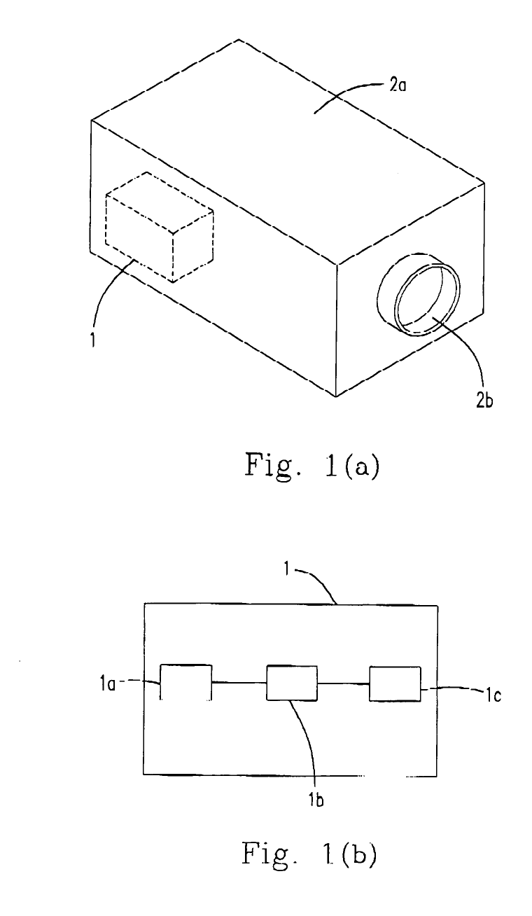

The present invention will now be described more specifically with reference to the following embodiment. Please refer to FIG. 1(a). FIG. 1(a) illustrates a projection device with a microprocessor module according to a preferred embodiment of the present invention. The projection device 2a includes the microprocessor module 1 and the projector 2b. The microprocessor module 1 receives a data signal including image format flies, document format files, or video format files, and then converts these files into an output signal. The projector 2b is electrically connected to the microprocessor module 1 and receives the output signal to project the image onto a wall.

Please refer to FIG. 1(b). FIG. 1(b) illustrates an electrical block diagram of the microprocessor module according to a preferred embodiment of the present invention. The microprocessor module 1 includes the data input device 1a, the data processing device 1b, and the signal output device 1c. The data input device 1a receives the data signal from other storage mediums. And the data processing device 1b which is electrically connected to the data input device 1a converts the data signal into an output signal. Finally, the signal output device 1c which is electrically connected to the data processing device 1b outputs the output signal to the projector 2b.

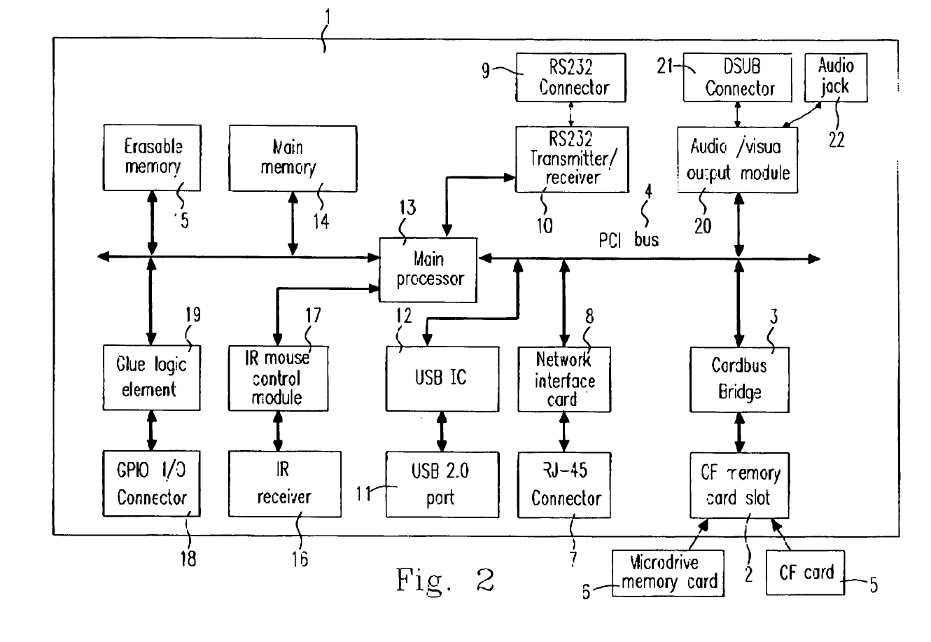

Referring to FIG. 2. FIG. 2 illustrates an electrical block diagram of the projection device with a microprocessor module according to a preferred embodiment of the present invention. The microprocessor module 1 of the projection device includes the Compact Flash (CF) memory card slot 2 and the Cardbus Bridge 3 as a data input device. But the type of data input device is not limited in the present invention. It can be any industrial standard interface input device, such as a network interface, a RS-232 interface, or a universal serial bus (USB) interface. The Compact Flash (CF) memory card slot 2 and the Cardbus Bridge 3 can transmit data stored in a CF memory card 5 or a Mocrodrive Memory Card 6 developed by IBM Corporation. A network interface includes a RJ45 connector 7 and a network interface card 8, which transmits network data from network. A RS-232 interface includes the RS-232 transmitter/receiver 10 which transmits data through the RS-232 connector 9. Also a universal serial bus interface includes the USB IC 12 which transmits data through the USB 2.0 port 11.

Please refer to FIG. 2 again. The main processor 13, the main memory 14 (RAM), and the erasable memory 15 are used as the data processing device. The main processor 13 processes the data signal from the main memory 14 where data are temporarily stored. The erasable memory 15 where the basic communication protocols and the drivers of all elements in the microprocessor module 1 are stored can help the main processor communicate with other peripheral devices. The data processing device may further include a graphic processing unit (GPU) (not shown) which may be built in the main processor 13 for helping the main processor 13 process digital video format files. Besides, an infrared (IR) module and a General-Purpose I/O (GPIO) connector may be used for controlling the functions of the projector 2b. The infrared (IR) module includes an IR receiver 16 and an IR mouse control module 17, which receives an IR control signal to control a mouse cursor. The GPIO connector 18 which is electrically connected to the Glue Logic element 19 is built in the microprocessor module 1 for controlling other peripheral devices. The audio/visual output module 20, the DSUB connector 21, and the audio jack 22 are used as the signal output devices of the microprocessor module 1. The audio/visual output module 20 transmits the audio/visual data which are generated by the data processing device. The audio/visual data are then transmitted to the projector through the DSUB connector 21 and the audio jack 22.

The operating system of microprocessor module 1 can be the Windows CE developed by the Microsoft Corporation. It includes an Office Viewer software for processing and playing Microsoft Office format files, such as Word, Excel, PowerPoint and etc, or other graphic format files, such as JPEG and BMP etc. With an aid of the GPU, the projector can also play digital files for multimedia, such as MPEGO AVI, and QUICKTIME etc. Furthermore, if it needs to support more file formats or to enhance the functions of the control software, the user only needs to update the firmware of the erasable memory 15. Therefore, the fictions of the projection device can be upgraded continuously, which can save user's money from buying a new projector with new functions.

According to the above, the projection device of the present invention receives multimedia data from the data input device via the PCI bus 1, while the microprocessor module processes and transmits the multimedia data to the signal output device via the PCI bus 4. Therefore, the projector projects the image signal onto a wall through the microprocessor module. Because the conventional projector only uses a digital signal processor (DSP) for processing the input data, which can only process graphic formats files not video formats files. The application of the projector is limited. On the contrary, the projection device with a microprocessor module of the present invention can process and play not only graphic files, but also the Office format files and the multimedia format files without format converting process. Besides, the functions of the projection device of the present invention can be upgraded simply by updating the firmware in the erasable memory. Accordingly, it can be applied to the condition of a presentation, a lecture, a meeting, or a training lesson and users can prepare a presentation more freely and easily without converting these format files first.

While the invention has been described in terms of what are presently considered to be the most practical and preferred embodiments, it is to be understood that the invention need not to be limited to the disclosed embodiment. On the contrary, it is intended to cover various modifications and similar arrangements included within the spirit and scope of the appended claims which are to be accorded with the broadest interpretation, so as to encompass all such modifications and similar structures. Accordingly, the invention is not limited by the disclosure, but instead its scope is to be determined entirely by reference to the following claims.

What is claimed is:

1. A projection device, comprising:
a microprocessor module for receiving a data signal including an image format file, a document format file, and a video format file to be converted into an output signal; and
a projector electrically connected to said microprocessor module for receiving said output signal.

2. The device according to claim 1, wherein said microprocessor module further comprising:
a data input device for receiving said data signal;
a data processing device electrically connected to said data input device for converting said data signal into said output signal; and
a signal output device electrically connected to said data processing device for providing said output signal to said projector.

3. The device according to claim 2, wherein said data input device comprises a network interface connector to be an input interface thereof.

4. The device according to claim 2, wherein said data input device comprises a serial port connector to be an input interface thereof.

5. The device according to claim 2, wherein said data input device comprises a universal serial bus connector to be an input interface thereof.

6. The device according to claim 2, wherein said data input device comprises an IEEE1394 connector to be an input interface thereof.

7. The device according to claim 2, wherein said data input device comprises a memory card slot to be an input interface thereof.

8. The device according to claim 2, wherein said data processing device further comprise.
a main processor for processing said data signal;
a main memory for storing a data temporarily; and
an erasable memory for storing basic communication protocols and all drivers of elements on said microprocessor module.

9. The device according to claim 8, wherein the software operating system of said data processing device is Microsoft Windows CE.

10. The device according to claim 9, wherein the software operating system of said data processing device comprises a data processing software for processing Microsoft Office files and image files.

11. The device according to claim 2, wherein said data processing device further comprises a graphic processing unit (GPU) for processing a file having a digital video format.

12. The device according to claim 11, wherein said GPU provide a processing means for file formats including MPEG1, MPEG2, MPEG4, AVI, REAL MEDIA, and QUICKTIME MOVIE.

13. The device according to claim 2, wherein said signal output device further comprises an audio-visual output module for transferring said output signal to said projector.

14. The device according to claim 1, wherein said microprocessor module further comprises a GPIO connector electrically connected to a peripheral device.

15. The device according to claim 1, wherein said microprocessor module further comprises an TR device for receiving an IR control signal.

16. A projection device with a microprocessor module, comprising:
a memory card device for being inserted therein by a memory card to provide a data signal including an image format file, a document format file, and a video format file;
a microprocessor module for receiving said data signal to be converted into an, output signal; and
a projector electrically connected to said microprocessor module for receiving said output signal.

17. The device according to claim 16, wherein said microprocessor module further comprises:
a data input device for receiving said data signal;
a data processing device electrically connected to said data input device for converting said data signal into said output signal; and
a signal output device electrically connected to said data processing device for providing said output signal to said projector.

18. The device according to claim 17, wherein said data processing device further comprises:
a main processor for processing said data signal;
a main memory for storing a data temporarily; and
an erasable memory for storing basic communication protocols and all drivers of elements on said microprocessor module.

19. The device according to claim 17, wherein said data processing device further comprises a graphic process unit (GPU) for processing video format files.

20. The device according to claim 17, wherein said signal output device further comprises an audio-visual output module for transferring said output signal to said projector.
